(19) United States
(12) Patent Application Publication
(10) Pub. No.: US 2009/0120761 A1
(43) Pub. Date: May 14, 2009

(54) Field configurable vending machine system

(75) Inventors: Dana Matthew Bashor, Hidden Hills, CA (US); William Charles Stevenson, Chatsworth, CA (US)

Correspondence Address: DANA BASHOR, 25139 JIM BRIDGER ROAD, HIDDEN HILLS, CA, 91302, US

(73) Assignee: DB DESIGN INCORPORATED, CULVER CITY, CA (US)

(21) Appl. No.: 11/983,495

(22) Filed: Nov. 9, 2007

(51) Int. Cl. G07F 9/10

(52) U.S. Cl. 194/350

(57) ABSTRACT

A vending machine system having the advantages of field configurability to achieve satisfying customers' product variety demands at a given vending sales location is disclosed. In general, a plurality of low cost, “dumb” application-specific slaved vending modules may be attached to and controlled by a host vending module possessing a sophisticated electronic control capability, the purpose of said system being to economically address the storage, sale and delivery of an expansive variety of vended goods while utilizing the least available space and financial resources needed to achieve this goal.

### BACKGROUND OF THE INVENTION

1. Field of the Invention

A vending machine possessing the characteristics of being configured in the field to achieve the goal of customizing the vending installation to fit the needs and desires of many specific vending locations via adaptive vending, dispensing and control modules and sub-modules is described.

2. Description of the Prior Art

The process of machine vending of physical articles and fluids, also called automated merchandising has been understood for well over a century. In fact, there is a history of mechanical vending in response to a deposited coin that dates back as far as ancient Greece, where holy water or oil would be vended at Pagan temples as a worshipper deposited coins into a mechanism that opened a valve to drain a small reservoir of liquid into the purchaser's own vessel.

Vending refers to the act of localized storing and distribution of materials, goods and services in an “on-demand” basis to consumers that have authority to receive them from storage. Authority to vend a product or good may be given in response to the deposit of value in a vending system, or by the mere act of permitting the vending mechanism to operate by sending an authorizing signal from a management source. Vending machines may also include sophisticated inventory management and delivery systems suitable for functions such as controlled distribution of sub-assemblies and parts in a manufacturing venue. Over the ages, vending machines have been produced that will dispense almost any product, material or fluid one can think of that may be delivered in individualized portions. There are even vending machines that prepare cooked foods or brew beverages on demand of the purchaser.

Consumers are familiar with modern self-contained vending machines that typically possess the ability to accept multiple forms of payment, including coins, currency, electronic credit or debit cards, and even from radio frequency payment credit transducers or other proprietary electronic circuits before dispensing their wares to the purchaser, and these vending machines may also possess the ability to perform many other functions related to operating the vending business itself, including sales and inventory tracking functions, tracking of machine operating functions and failure modes, food safety and various other inventory and accounting functions. The American vending industry, through such organizations as the National Automated Merchandising Association, has standardized upon both data and machine function protocols and mechanisms in order to achieve high quality and reliability in vending equipment and business operations. The most accepted standardized protocols involved are named MDB and DEX, and provide the vending business operator the ability to track a very broad range of data that is potentially important to the operation of a successful vending business. For the vending machine manufacturer, these protocols allow standardization of electronic controls such that the various controls are semi-autonomous in operation, a feature allowing manufacturers the ability to produce a variety of complex vending machines using standardized sub-modules as building blocks in their machine control circuitry. An unintended by-product of this standardization is that these control modules have become rather complex and thus costly to implement for many applications, especially when used in vending systems aimed at limited sales volume applications.

Because the typical vending machine is limited in the variety of objects or products it may dispense, it becomes necessary to employ up to several different vending machine types to satisfy the variety of goods desired to be sold at a given location. This typically results in rows of individual specialized vending machines lining a wall in a break room or other suitable location that physically exposes them to the desired customer base. To meet the demand for a variety of foods, snacks, candies/confections and chilled beverages, typically at least three vending machines are required, which may occupy precious building space as large as 10½ feet wide by 3 feet deep. Also, when placed in smaller sales volume locations, such an installation is so very expensive for the vending route operator that the smaller location usually is offered far less valuable older, even obsolete vending machines, at whatever minimal expenditure that the operator deems acceptable for his business. Further, in such small locations floor space is typically limited, and thus represents a premium value business asset that cannot be wasted on quantities of unnecessarily large vending equipment for a small market venue.

To consolidate the payment and dispensing control functions of a bank of vending machines, several machines having their own controls and payment acceptance mechanisms may be interconnected via a local communication method that collects functional data from every machine and instructs individual machines that a purchaser may have a financial credit due, a credit that can be used at another machine in the locally networked group of machines without having to deposit individual payment into each machine used. Such a master/slave machine control system may provide some operating advantages to the vending customer and vending business operator, however the need for multiple machines to allow delivery of a wide variety of products increases both the operational cost of a given installation and the floor space utilized such that many installations are economically unfeasible for an operator to service. This is especially true in venues that may have limited space available and/or a comparatively smaller population of customers to sell to.

To overcome the available space and capital expenditure problems caused by the need for multiple machine varieties at a given location, several so-called “combination” vending machines have come into existence that divide their internal space between refrigerated beverages and non-refrigerated snacks and confections. This frequently results in one vending machine enclosure that contains both a refrigerated section and a non-refrigerated section, with common controls shared by both operating sections. Due to the physical limitations imposed by vending location door and stairway access, or available floor space for vending machine installation, a smaller vending machine is desirable but results in a vending machine possessing a rather limited number of saleable units or product varieties that may be made available to the typical “combination” vending machine's customers. These so-called “compact vending machines” can be a successful method for a vending business operator to improve their economic conditions in small or low traffic venues, however there is a severe limit to how many different types of refrigerated and non-refrigerated product choices may be made available to customers and a limitation in the quantity of vendable units available for sale. This results in the need of additional machines on location to accommodate the customers' desire for an increasingly wider variety of product choices in any given location, thus reverting to the difficulties previously described above, that of supplying multiple vending machines to satisfy a given location's desire for both product selection variety and available stored quantities of vended goods.

To summarize, it may require several vending machines to present a suitable variety of vendable products at a vending sales venue. Each of these vending machines will possess a complete cash acceptance and crediting control system, plus the necessary drives and controls to successfully vend a variety of product package or vessel shapes and sizes. This causes both the vending operator and their customer locations added expense to accommodate. Thus there is a need for a very compact, cost effective vending system that meets the vend customers' desires for broad product variety and ample unit supply in a limited physical space at minimal energy cost, and the vending business operators' need for an economic and capable system to meet these demands.

Therefore it is an object of the present invention field configurable vending machine system to provide the vending mechanisms needed to satisfy the desires of a smaller vending location for ample product variety choice and supply, while also limiting the expense of redundant additional control and payment circuitry and various associated mechanisms through incorporating a convenient centralized payment collection means and a host control that services the operational signaling requirements of every connected vending mechanism. It is also an object of the present invention field configurable vending machine system to accomplish this goal using easily transported compact modules that are product variety specific and individually positioned in relation to the host control module, which when assembled at the location result in an individually customizable vending system that requires the least floor space for installation, lowers energy consumption and requires the lowest possible financial commitment by vending business operators to successfully achieve this result.

### SUMMARY OF THE INVENTION

Embodiments of the present invention field configurable vending machine system generally provide methods, systems and articles of manufacture that facilitate the resolution of a variety of conflicts between vending customers' desires and vending business operator's needs.

A first preferred embodiment provides a compact modular vending system that offers the variety and volume of products found in at least three ordinary vending machines, however accomplishes this feat while occupying a physical space of less than half that of a plurality of ordinary vending machines that would be required to perform the same desirable functions. A further advantage of this first embodiment is that consolidating control circuitry to a host module and improving the utility of manufacturing materials used considerably reduce the cost of manufacture of a vending system. An exceptional advantage of the present invention field configurable vending machine system is to provide the vending route operator a smaller, lighter weight module for each specific vending function, which allows said operator to deliver and install the present invention field configurable vending machine system using ordinary tools and family-style vehicles rather than requiring heavy duty machine moving services to move and install far larger and heavier ordinary vending machines.

Second and third preferred embodiments of the present invention field configurable vending machine system provide additional slaved vending modules for expanded availability and stocks of refrigerated and non-refrigerated packaged goods and beverages. These expansion modules may be securely mechanically attached to and electrically connected with the said first preferred embodiment field configurable vending machine system, such that these second and third preferred embodiments allow the economical expansion of an existing installed vending system to include a broadened variety and an increased volume of machine vendable products made available at a given sales venue.

Yet another embodiment provides an improved vending host control plan that ensures reliable, secure vending of products, storage and reporting of essential data relating to vending operations and sales, and acceptance and distribution of various payment methodologies while reducing manufacturing costs and vending route operator effort.

### BRIEF DESCRIPTION OF THE DRAWINGS

It is to be noted that the appended drawings illustrate only typical embodiments of the present invention field configurable vending machine system and are therefore not to be considered as limiting the scope of the invention, for the invention may admit to other equally effective embodiments.

FIG. 1 illustrates a first preferred embodiment field configurable vending machine of the present invention field configurable vending machine system.

FIG. 2 illustrates the host control vending module assembled to a refrigerated beverage vending module of the present invention field configurable vending machine system.

FIGS. 3A-3C illustrate alternate preferred embodiment slaved vending modules of the present invention field configurable vending machine system.

FIG. 4 is a block diagram illustration relating the various sub-modules and types, and host control vending machine module of the present invention field configurable vending machine system.

FIG. 5 is an isometric blow-apart view of another preferred embodiment larger-scale vending machine installation relating the various sub-modules and types, and host vending machine of the present invention field configurable vending machine system.

FIG. 6 is a front view illustration of a preferred embodiment large-scale installation of the present invention field configurable vending machine system showing the compact floor space used by such an installation.

FIGS. 7A & 7B are flow charts illustrating the basic processing functions performed by the host control circuitry in response to customer input of payment and item selection.

### DETAILED DESCRIPTION OF THE PREFERRED EMBODIMENTS

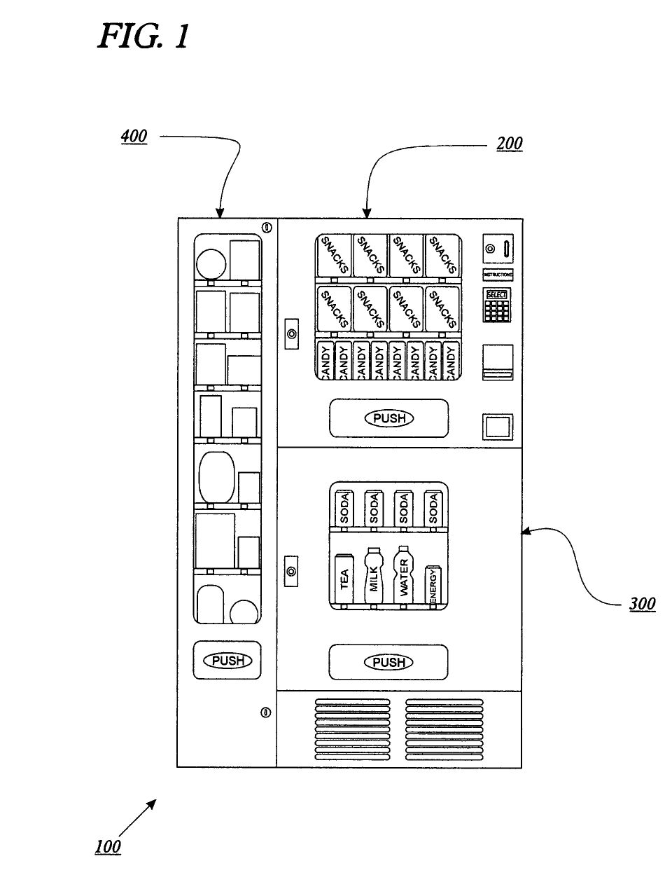

FIG. 1 is a first preferred embodiment of the present invention field configurable vending machine system 100, consisting of a host control non-refrigerated snack/confection vending module 200, a slaved refrigerated beverage vending module 300, and a non-refrigerated slaved vending module 400. This illustrates the installed relationship of the three compact vending modules required to provide a minimally broad variety of both refrigerated and non-refrigerated foods, snacks, candies/confections and beverages at a small vending location having limited available space for ordinary commercial vending machines. As illustrated herein, the comparatively heavy slaved refrigerated beverage vending module 300 serves as a foundation upon which the host control non-refrigerated snack/confection vending module 200 is stacked and mechanically anchored together to the slaved refrigerated beverage vending module 300 by a common hardware connection. Shown to the left side of this assembly view is a comparatively narrow and tall non-refrigerated slave vending module 400, which too is mechanically attached to the other two modules using common hardware. As such a system 100 may also be reconfigured later when needed by customer demand. This first preferred embodiment of the present invention field configurable vending machine system 100 represents the most compact and economical approach to providing the widest range and variety of products to a limited market, while allowing easy and economical future expansion as the customer's needs and desires increase.

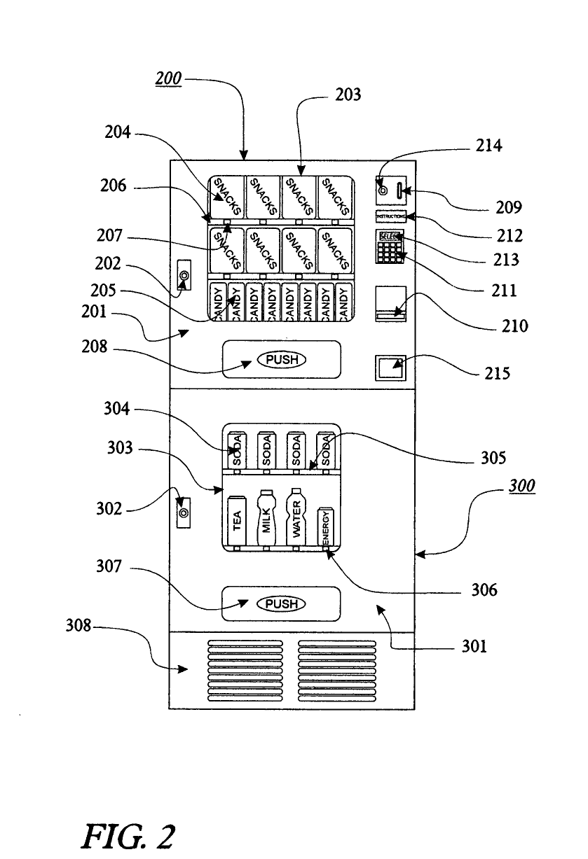

To better understand the capability of the present invention field configurable vending machine system 100, refer now to FIG. 2, an illustration of the stackable host control non-refrigerated snack/confection vending module 200 and slaved refrigerated beverage vending module 300 portions of the present invention field configurable vending machine system 100. The non-refrigerated host control vending module 200 consists of an enclosure, (not illustrated here) having a hinged front door 201 and lock 202 to secure the door 201 closure. Said door 201 also possesses a glazed window opening 203 allowing view of snacks 204 & candies 205 product displayed for sale located interior of door 201 on shelves 206 having product locating/identifying characters 207 that are used by the vending customer to identify and order desired products 204 & 205. Upon input of coin into coin slot 209 or currency into bill validator 210 sufficient to make a purchase, display panel 213 informs the vending customer that the machine is ready to accept input of product identification number 207 of desired product into keyboard 211. As customer completes input of desired product identification number 207, the electronic controls, (not illustrated here) of host control non-refrigerated snack/confection vending module 200 distribute the necessary electrical power and signals to effectuate delivery of the purchased product via delivery door 208, and concludes the sales cycle by returning any remaining cash credit from the sale to the customer via coin tray 215. Should the customer decide to not make a purchase after inputting coin or currency, or at any time desire that their deposited cash be returned, pushing coin return button 214 actuates the cash refund/change return cycle that delivers returned coin to the customer via the coin tray 215, or may also return unused paper currency via the front slot of the bill validator 210. For customer convenience an instruction panel 212 is also provided, informing the customer of the operational steps needed to make a purchase.

Continuing now with FIG. 2, see slaved refrigerated beverage vending module 300 that consists of an insulated storage cabinet, (not illustrated here) having a hinged front door 301 possessing a lock 302 to secure door 301 closure and protect the merchandise held within. Door 301 also has a display opening 303 where samples of beverages 304 stored within said slaved refrigerated beverage vending module 300 are displayed on shelves 305 that also have locating/identifying characters 306 that the vending customer uses to identify and order desired beverages 304 that will be delivered for retrieval at door 307. A self-contained closed-loop cycle refrigeration module 308 located at the base of said slaved refrigerated beverage vending module 300 provides the cooling energy necessary to keep the stored refrigerated beverages in module 300 at the desired temperature for pleasurable and safe consumption. FIG. 2 also illustrates that both the said slaved refrigerated beverage vending module 300 and the stackable host control vending module 200 are vertically positioned and mechanically attached to each other, thus making a solid and secure foundation assembly that may be expanded upon by the addition of one or more slaved vending modules mechanically attached thereto. Electrical connection means between said stackable host control vending module 200 and said slaved refrigerated beverage vending module 300, (connection means that are not illustrated here) allow power and control communication between said host control vending module 200 and said slaved refrigerated beverage vending module 300 in accordance with the programming of the host control circuitry and input of payment and purchase instructions from customers. Mechanical features are provided to said host control vending module 200 and said slaved refrigerated beverage vending module 300 that allow the reconfiguration of the product storage & distribution shelves and vend mechanisms in the field. This feature allows an additional level of flexibility to the vending business operator in meeting the changing appetites and demands of their customers.

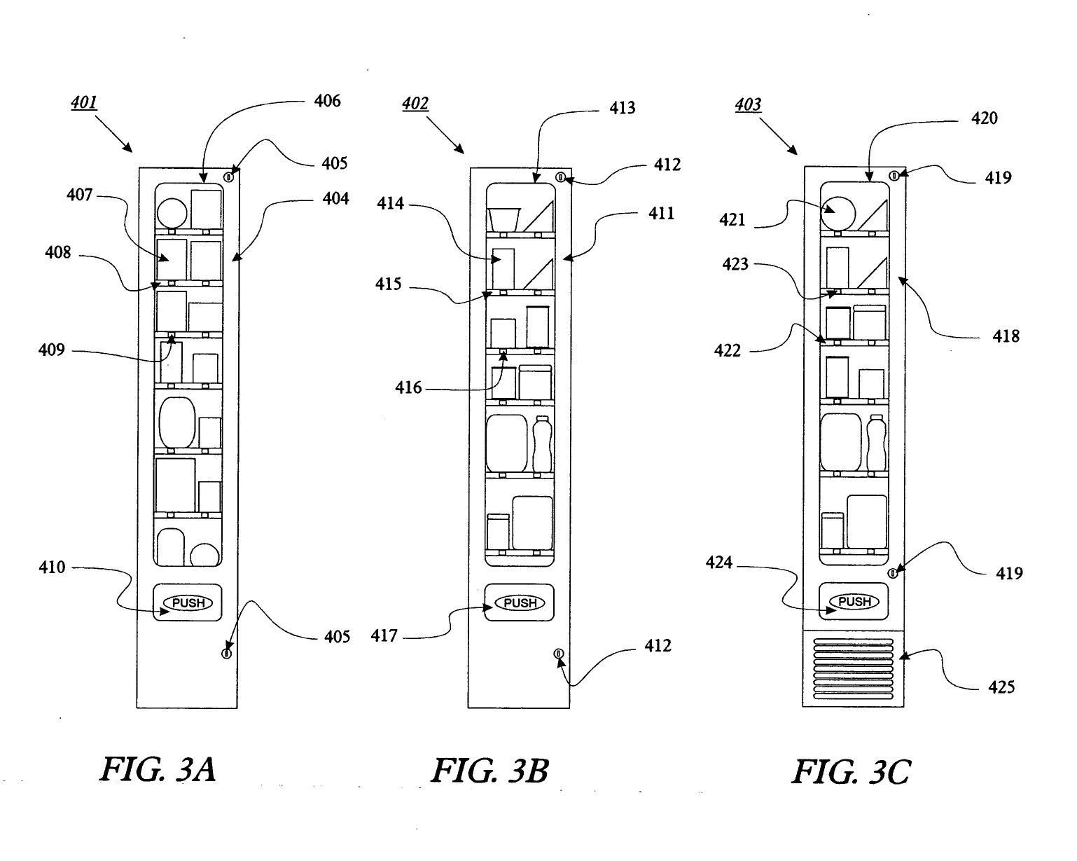

Viewing FIGS. 3A through 3C, illustrating alternate preferred embodiment add-on vending modules of the present invention field configurable vending machine system 100 and starting with FIG. 3A that illustrates a slaved ambient vending module 401, begins the discussion of a variety of useful add-on expansion modules. Any of said add-on expansion modules are configured as comparatively tall & narrow, essentially rectangular cabinets that mechanically attach to both the said non-refrigerated host control vending module 200 and to the said slaved refrigerated beverage vending module 300, creating the mechanically robust and secure said field configurable vending machine assembly 100. Additionally, each said add-on expansion module also has electrical connection means between said host and slave modules, (connection means that are not illustrated here) that provide power and control communication between said add-on modules and the said host controls contained within the said stackable host control vending module 200 (illustrated earlier) in accordance with the programming of the said host control circuitry and input of payment and purchase instructions from customers. Mechanical features are provided to all said expansion add-on modules that allow the reconfiguration of their product storage & distribution shelves, and vend mechanisms in the field. These features provide additional levels of flexibility to the vending business operator in meeting the demands of their customers.

FIG. 3A also illustrates a slaved ambient temperature vending module 401 that is an ambient temperature product storage cabinet of essentially rectangular shape, (not illustrated here) that possesses a hinged door 404 which is closably secured by one or more key locks 405, to securely store vendable products 407 there within. Said door 404 has a glazed opening 406 that allows viewing of the inventory of vendable products 407 that are stored within said slaved ambient vending module 401 on adjustable shelves 408 having locating/identifying characters 409 that the vending customer uses to identify and order said desired vendable products 407 that will be delivered by said slaved ambient temperature vending module 401 for customer's retrieval at door 410.

Then, drawing FIG. 3B illustrates a low-cost slaved cold-cabinet vending module 402 used to expand the chilled/perishable products capacity of the present invention field configurable vending machine system 100, consisting of a thermally insulated cabinet of essentially rectangular shape, (not illustrated here) having at least one input and at least one exhaust ventilation interface, (not illustrated here) that may connect with mating at least one input and at least one exhaust ventilation interfaces located at one side of the said slaved refrigerated beverage vending module 300 (also not illustrated here). Slaved cold-cabinet vending module's 402 configuration provides the ability to tap into the refrigeration capability of said slaved refrigerated beverage vending module 300 to chill additional supplies of refrigerated vendable products. The said essentially rectangular insulated cabinet possesses a hinged door 411, that is secured closed by one or more key locks 412, said door 411 having a glazed opening 413 that allows viewing of the inventory of vendable products 414 that are stored within said slaved cold-cabinet vending module 402 on adjustable shelves 415 having locating/identifying characters 416 that the vending customer uses to identify and order desired said products 414 that will be delivered by said slaved cold-cabinet module 402 for retrieval at door 417.

Now referring to FIG. 3C, which illustrates a slaved self-refrigerated vending module 403 used to expand the refrigerated/frozen products capacity of the present invention field configurable vending machine system 100, consisting of a thermally insulated cabinet of essentially rectangular shape, (not illustrated here) possessing a hinged door 418, that is secured closed by one or more key locks 419, said door 418 having a glazed opening 420 that allows viewing of the inventory of vendable products 421 that are stored within said slaved self-refrigerated vending module 403 on adjustable shelves 422 having locating/identifying characters 423 that the vending customer uses to identify and order desired products 421 that will be delivered by said slaved self-refrigerated vending module 403 for customer retrieval at door 424. A self-contained closed-loop refrigeration module 425 located at the base of said self-refrigerated vending module 403 provides the additional cooling energy necessary to keep the stored refrigerated/frozen products 421 stored in said slaved self-refrigerated vending module 403 at the desired temperature for pleasurable and safe consumption.

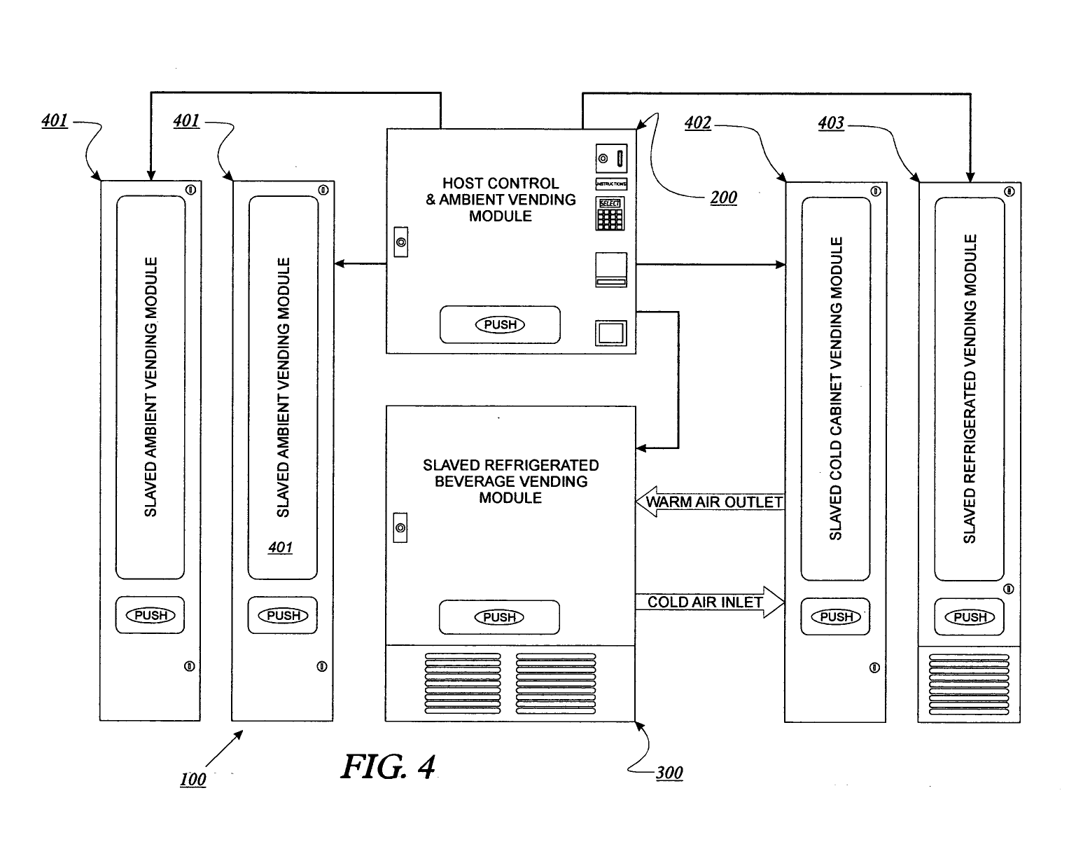

See now in FIG. 4 a block diagram illustration relating the various types of said add-on expansion modules to said host control & ambient vending module 200 of the present invention field configurable vending machine system 100. Said slaved refrigerated beverage module 300 is shown as the center mechanical foundation of the system, upon which vertically mounts said host control & ambient vending module 200. Viewing to the left, one sees two of said slaved ambient vending modules 401a & 401b that provide expanded vending of room temperature products. To the immediate right of said slaved refrigerated beverage module 300 is shown a slaved cold cabinet vending module 402 that receives cold air from said slaved refrigerated beverage module 300 and returns used warm air to said slaved refrigerated beverage module 300 thus utilizing the refrigeration available from said slaved refrigerated beverage module 300 for energy efficiency in vending additional chilled vended products. At the far right of the said present invention field configurable vending machine system 100 is a said slaved self-refrigerated vending module 403 that further expands the variety of refrigerated vended products to also include frozen products as well. It should be easily understood from this illustration that additional expansion modules having additional or other features not discussed herein that may be introduced as modular parts of the present invention field configurable vending machine system 100.

By viewing illustration FIG. 4 one can easily understand that said system 100 may be field configured for many vending applications and locations by simply adding more or less said expansion modules to present invention field configurable vending machine system 100. Present invention field configurable vending machine system 100 is thus only limited in scope by the ultimate capacity of the control electronics circuitry used and the physical space available for vending machine installation at a given location. A mechanical limitation of this configuration is that at least three modules are required to complete a viable installed present invention field configurable vending machine system 100. Any installed vending system according to the present invention field configurable vending machine system 100 requires that both the said host control vending module 200 and the said slaved refrigerated beverage vending module 300 are stacked on top of and connected to each other, and at least one said additional expansion slave module of any type must also be connected thereto to complete the installed system. It is therefore clearly understood that beyond the said minimum of module elements there is no particular configuration or number of differing said add-on slaved expansion modules required to make the present invention field configurable vending machine system 100 a viable installation. It is also clear, by the illustration of common between them “COLD” and “WARM” air current flow arrows, that the slaved cold cabinet must be positioned in direct contact with one or another side surfaces of said slaved refrigerated beverage vending module 300 in order to access the refrigerated air sourced from said slaved refrigerated beverage module 300 in order to function.

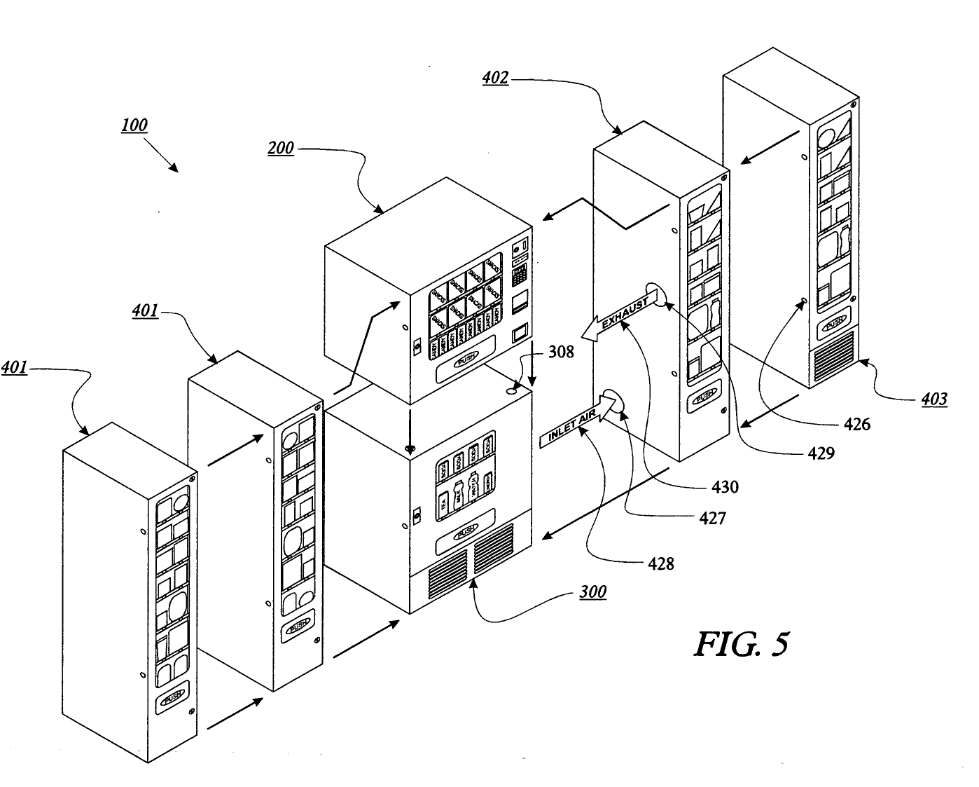

Next, FIG. 5 illustrates an exploded isometric view of an expanded field installation of present invention field configurable vending machine system 100 wherein a plurality of said add-on expansion modules are incorporated into the installation. At the far left of this view a first said slaved ambient vending module 401a is paired with a second said slaved ambient vending module 401b with both located to the immediate left of the said slaved refrigerated beverage vending module 300, said slaved refrigerated beverage vending module 300 is also shown positioned as a stable base to support the said stackable host control & ambient vending module 200. Said host control & ambient vending module 200 mechanically connects in the field installation to said slaved refrigerated beverage vending module 300 using bolts or other common hardware connection 308 means to secure said host control vending module 200 to the top surface of said slaved refrigerated beverage vending module 300. Illustrated herein said host control vending module 200 and said slaved refrigerated beverage vending module 300 together form a vertically oriented rectangular cabinet assembly previously detailed in FIG. 2. To the right of this assembly of said host control vending module 200 and said slaved refrigerated beverage vending module 300 are illustrated another two said add-on expansion modules, the first of which is a said slaved cold cabinet vending module 402 whose said inlet air 428 interface connection 427 and said exhaust 430 interface connection 429 mate with corresponding interface connections, (not illustrated here) located on the right side of said slaved refrigerated beverage vending module 300, thus allowing free flow of circulated chilled air there between to share the capacity of the said self-contained refrigeration module 308 located in the base of said slaved refrigerated beverage vending module 300 in economically maintaining chilled temperatures within said slaved cold cabinet vending module 402.

Continuing now with FIG. 5, the last add-on expansion module illustrated here at the far right side of the view is the said slaved self-refrigerated vending module 403 that has its own self-contained closed-loop refrigeration module, allowing it to be positioned wherever physically convenient relative to said slaved self-refrigerated vending module 403. Said slaved self-refrigerated vending module 403 is illustrated having a common hardware connection 426 means to secure said slaved self-refrigerated vending module 403 to said slaved cold cabinet vending module 402. These common connection 426 means are repeated on all other said add-on expansion modules such that they may be mechanically attached together in the field to create a monolithic assembly in the form of said present invention field configurable vending machine system 100, possessing the capability of vending a uniquely broad variety of room temperature, chilled and refrigerated or frozen foods, confections and beverages. The configuration illustrated here in FIG. 5 represents but one of many configuration possibilities, and therefore does not limit the eventual installed configuration of said present invention field configurable vending machine system 100.

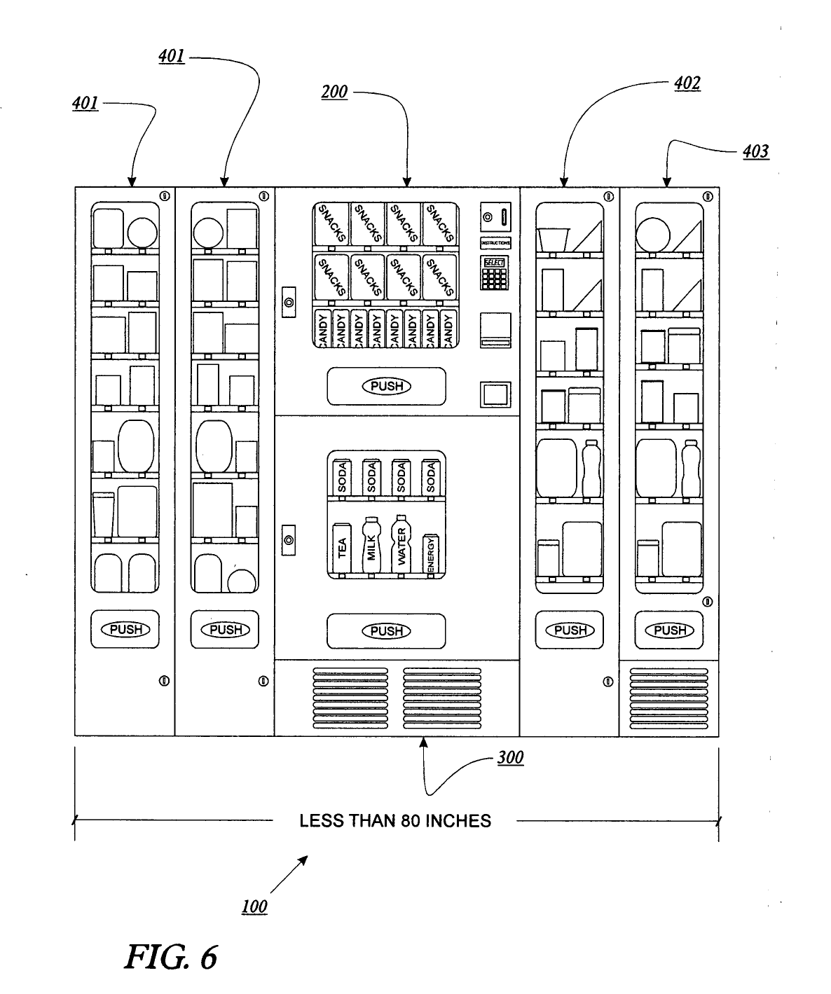

Viewing FIG. 6 discloses a frontal view of an installation of said present invention field configurable vending machine system 100 assembly, (as previously illustrated in FIG. 5) consisting of a first said slaved ambient vending module 401a, a second said slaved ambient vending module 401b, the said slaved refrigerated beverage vending module 300, said host control vending module 200, said slaved cold cabinet vending module 402, and said slaved self-refrigerated vending module 403 completely assembled into a monolithic system occupying a floor space of less than 80 inches in length. This FIG. 6 illustrated present invention field configurable vending machine system 100 represents what should be considered a maximum practical need installation, as it utilizes a plurality of slaved modules that deliver ambient temperature foods, candies, snacks & confections; microwaveable shelf-stable entrees & meals; chilled foods, fruits & salads, refrigerated cold cuts, sandwiches & meals; refrigerated and chilled beverages of types including those that are bottled, canned, pouched or boxed; altogether some 76 selections are illustrated herein, representing more selections than are contained within a bank of typical commercial vending machines measuring twice this vending system's dimension.

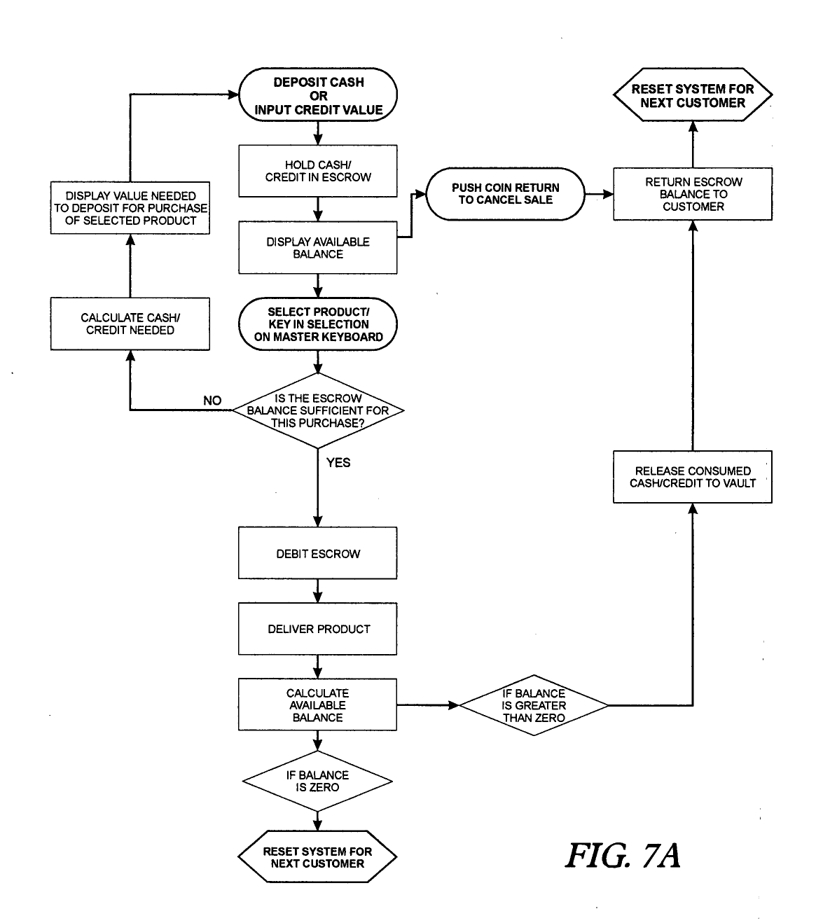

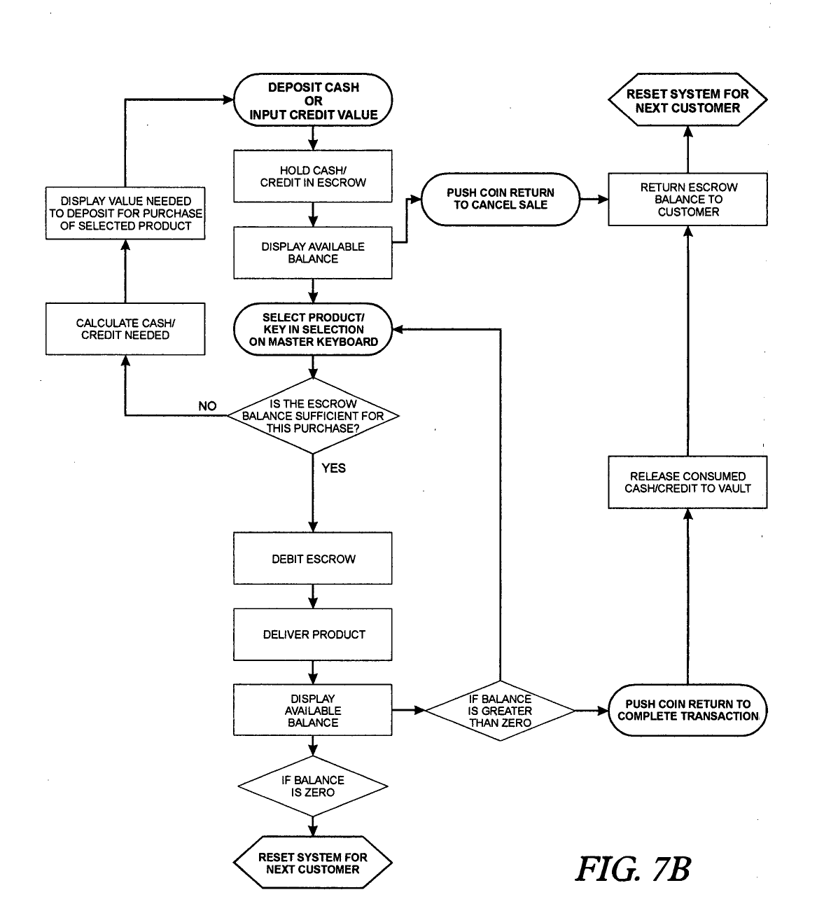

Moving now to FIG. 7A is illustrated a logic diagram of operational functions managed and controlled by said host control vending module 200, (not illustrated here in this view) as part of said present invention field configurable vending machine system 100 assembly. The vend customer may input a cash or credit value to begin the sequence of activity, with the cash/credit balance held in escrow and indicated on said display 213 while the customer makes their purchase decision. Said customer then inputs their desired selection identifier 207 into said host control vending module 200 via said keyboard 211. Said host control vending module 200 then calculates the difference between said escrowed cash/credit and the vend price of said selection and determines if there is sufficient escrowed credit to pay for a chosen purchase. If there is insufficient cash/credit in escrow, said display 213 indicates the first option of depositing additional cash/credit to secure a purchase, or to alternatively allow a substitute purchase selection or the refund of deposited cash or credit value. If there is sufficient cash/credit escrowed to make said purchase, said host control vending module 200 debits the said escrow value and then delivers the ordered product. Concluding this cycle step causes said host control vending module 200 to calculate available cash/credit balance remaining in escrow. If there is a zero balance, the said host control vending module 200 resets to make the next purchase possible. If there is an outstanding cash/credit balance left in escrow, the said host control vending module 200 returns said balance to customer before resetting itself for the next vend customer. If after a cash/credit balance is established in escrow the said customer pushes said coin return button 214, all incomplete sales transactions are cancelled and any remaining cash/credit balance is returned to the customer.

Looking now at FIG. 7B is illustrated a first alternate logic diagram of operational functions managed and controlled by said host control vending module 200, (not illustrated here in this view) as part of said present invention field configurable vending machine system 100 assembly wherein the control logic has been configured to allow multiple purchases between inputs of cash/credit. The vend customer may input a cash or credit value to begin the sequence of activity, with the cash/credit balance held in escrow and indicated on said display 213 while the customer makes their purchase decisions. Said customer then inputs their desired selection identifier 207 into said host control vending module 200 via said keyboard 211. Said host control vending module 200 then calculates the difference between said escrowed cash/credit and the vend price of said selection and determines if there is sufficient escrowed credit to pay for a chosen purchase. If there is insufficient cash/credit in escrow, said display 213 will indicate the first option of depositing additional cash/credit to secure a purchase, or to alternatively allow a substitute purchase selection or refund of deposited cash or credit value. If there is sufficient cash/credit escrowed to make said purchase, said host control vending module 200 debits the said escrow and then delivers the ordered product. Said host control vending module 200 now indicates the remaining cash/credit balance on said display 213, and then offers the choice of making an additional vend selection or returning the remaining cash/credit balance to the customer. If said customer chooses to cash out the balance, they merely push the coin return button to effect that outcome. Should said customer choose another vend selection, then host control vending module 200 repeats the steps leading to delivery of product. This process continues until either there is no longer cash/credit balance available, or the customer pushes coin return button 214 to complete their transactions and receives any remaining cash/credit balance as a refund, whereupon said host control vending module 200 resets itself for the next vend customer. As said before, if at any time after a cash/credit balance is established in escrow the said customer pushes said coin return button 214, all incomplete sales transactions are cancelled and any remaining cash/credit balance is returned to the customer.

While the foregoing is directed to embodiments of the present invention, other and further embodiments of the invention may be devised without departing from the basic scope thereof, and the scope thereof is determined by the claims that follow.

We claim:

1. A field configurable modular vending machine comprising:
A first ambient temperature vending module having;
a plurality of stored vendable products within a lockable enclosure, and
a means of delivering individual stored product units to a customer in response to customer's input/direction, and
a means of accepting, escrowing and storing payment, and
a means of returning unused credit to the vend customer, and
a first controller that directs functions of cash acceptance and value tabulation, product delivery and motor control, refunding remaining credit,
a means of electrical signal and power connection to control a plurality of additional slaved vending modules, and
a means of secure mechanical attachment to a plurality of additional vending modules, and
a means of connecting to an electrical power source; and,
a slaved second refrigerated vending module having;
a plurality of stored vendable products within a lockable temperature insulated enclosure, and
a means of delivering individual stored product units to a customer in response to electrical signals received from said first ambient temperature vending module's host control circuitry, and
a self-contained refrigeration means to chill the plurality of stored vendable products within this said temperature insulated enclosure, and
a means of temperature control to activate said self-contained refrigeration means in response to pre-set temperature limits, and
a means of electrically connecting to said first ambient temperature vending module's host control circuitry, and
a means of connecting to an electrical power source, and
a means of secure mechanical attachment to said first ambient temperature vending module, and
a means of secure mechanical attachment to said plurality of additional vending modules; and
a slaved third vending module having;
a plurality of stored vendable products within a lockable enclosure, and
a means of delivering individual stored product units to a customer in response to electrical signals received from said first ambient temperature vending module's host control circuitry, and
a means of electrically connecting to said first ambient temperature vending module's host control circuitry, and
a means of secure mechanical attachment to said first ambient temperature vending module, and
a means of secure mechanical attachment to said plurality of additional vending modules.

2. A field configurable modular vending machine according to claim 1 wherein said slaved third vending module is comprised of an ambient temperature enclosure.

3. A field configurable modular vending machine according to claim 1 wherein said slaved third vending module is comprised of a temperature insulated enclosure that connects to corresponding flowing air inlet and flowing air outlet ports of said second refrigerated vending module, thus securing cooling energy for chilling stored products.

4. A field configurable modular vending machine according to claim 1 wherein said slaved third vending module is comprised of a temperature insulated enclosure that also has a self-contained refrigeration means.

5. A field configurable modular vending machine according to claim 4 wherein said slaved third vending module is comprised of a temperature insulated enclosure that also has a self-contained unitized refrigeration module, and a temperature control to activate said self-contained unitized refrigeration module in response to pre-set temperature limits.

6. A field configurable modular vending machine comprising:
A first ambient temperature vending module having;
a plurality of stored vendable products within a lockable enclosure, and
a means of delivering individual stored product units to a customer in response to customer's input/direction, and
a means of accepting, escrowing and storing payment, and
a means of returning unused credit to the vend customer, and
a first controller that directs functions of cash acceptance and value tabulation, product delivery and motor control, refunding remaining credit,
a means of electrical signal and power connection to control a plurality of additional slaved vending modules, and
a means of secure mechanical attachment to a plurality of additional vending modules, and
a means of connecting to an electrical power source; and,
a slaved second refrigerated vending module having;
a plurality of stored vendable products within a lockable temperature insulated enclosure, and
a means of delivering individual stored product units to a customer in response to electrical signals received from said first ambient temperature vending module's host control circuitry, and
a self-contained refrigeration means, and
a temperature control to activate said self-contained refrigeration means in response to pre-set temperature limits, and
a means of electrically connecting to said first ambient temperature vending module's host control circuitry, and
a means of connecting to an electrical power source, and
a means of secure mechanical attachment to said first ambient temperature vending module, and
a means of secure mechanical attachment to said plurality of additional vending modules; and
a slaved third vending module having;
a plurality of stored vendable products within a lockable enclosure, and
a means of delivering individual stored product units to a customer in response to electrical signals received from said first ambient temperature vending module's host control circuitry, and
a means of electrically connecting to said first ambient temperature vending module's host control circuitry, and
a means of secure mechanical attachment to said first ambient temperature vending module, and
a means of secure mechanical attachment to said plurality of additional vending modules; and
a variable plurality of additional optional slaved expansion vending modules whose number is limited only by the capacity of said first ambient temperature vending module's said host control circuitry.

7. A field configurable modular vending machine according to claim 6 wherein at least one of said plurality of additional optional expansion modules is comprised of a temperature insulated enclosure that connects to corresponding flowing air inlet and flowing air outlet ports of said second refrigerated vending module, thus securing cooling power for stored products.

8. A field configurable modular vending machine according to claim 6 wherein at least one of said plurality of additional optional expansion modules is comprised of a temperature insulated enclosure that also has a self-contained refrigeration means.

9. A field configurable modular vending machine according to claim 8 wherein said at least one of said plurality of additional optional expansion modules is comprised of a temperature insulated enclosure that also has a self-contained unitized refrigeration module, and a temperature control to activate said self-contained unitized refrigeration module in response to pre-set temperature limits.

10. A field configurable modular vending machine according to claim 9 wherein said at least one of said plurality of additional optional expansion modules is comprised of a cold beverage dispensing mechanism.

11. A field configurable modular vending machine according to claim 9 wherein said at least one of said plurality of additional optional expansion modules is comprised of a temperature insulated enclosure that contains an ice cream vending capability.

12. A field configurable modular vending machine according to claim 9 wherein said at least one of said plurality of additional optional expansion modules is comprised of a temperature insulated enclosure that contains a packaged frozen food vending capability.

13. A field configurable modular vending machine according to claim 6 wherein said at least one of said plurality of additional optional expansion modules is comprised of a hot beverage dispensing mechanism.

14. A field configurable modular vending machine according to claim 13 wherein said at least one of said plurality of additional optional expansion modules is comprised of a coffee beverage brewing and dispensing mechanism.

15. A field configurable modular vending machine according to claim 6 wherein said at least one of said plurality of additional optional expansion modules is comprised of a food heating mechanism.

16. A field configurable modular vending machine according to claim 8 wherein said at least one of said plurality of additional optional expansion modules is comprised of a can dispensing mechanism.

17. A field configurable modular vending machine according to claim 8 wherein said at least one of said plurality of additional optional expansion modules is comprised of a bottle dispensing mechanism.

18. A field configurable modular vending machine according to claim 8 wherein said at least one of said plurality of additional optional expansion modules is comprised of both can and bottle dispensing mechanisms.

19. A field configurable modular vending machine comprising:
A first refrigerated vending module having;
a plurality of stored vendable products within a lockable temperature insulated enclosure, and
a means of delivering individual stored product units to a customer in response to customer's input/direction, and
a means of accepting, escrowing and storing payment, and
a means of returning unused credit to the vend customer, and
a first controller that directs functions of cash acceptance and value tabulation, product delivery and motor control, refunding remaining credit,
a means of electrical signal and power connection to control a plurality of additional slaved vending modules, and
a means of secure mechanical attachment to a plurality of additional vending modules, and
a means of connecting to an electrical power source; and,
a self-contained refrigeration means, and
a temperature control to activate said self-contained refrigeration means in response to pre-set temperature limits, and
a slaved second ambient temperature vending module having;
a plurality of stored vendable products within a lockable enclosure, and
a means of delivering individual stored product units to a customer in response to electrical signals received from said first refrigerated vending module's host control circuitry, and
a means of electrically connecting to said first refrigerated vending module's host control circuitry, and
a means of connecting to an electrical power source, and
a means of secure mechanical attachment to said first refrigerated vending module, and
a means of secure mechanical attachment to said plurality of additional vending modules; and
a slaved third vending module having;
a plurality of stored vendable products within a lockable enclosure, and
a means of delivering individual stored product units to a customer in response to electrical signals received from said first refrigerated vending module's host control circuitry, and
a means of electrically connecting to said first refrigerated vending module's host control circuitry, and
a means of secure mechanical attachment to said first refrigerated vending module, and
a means of secure mechanical attachment to said plurality of additional vending modules; and
a variable plurality of additional optional slaved expansion vending modules whose number is limited only by the capacity of said first refrigerated vending module's said host control circuitry.
